(19) United States
(12) Patent Application Publication
(10) Pub. No.: US 2007/0158470 A1
(43) Pub. Date: Jul. 12, 2007

(54) Oxygenating showerhead

(76) Inventors: Harold Roy Taylor, Stratford, CT (US); Vito James Carlucci, Stratford, CT (US); Martin A. Cohen, Ridgefield, CT (US)

Correspondence Address: STEVEN A. GARNER, ESQ.;CONAIR CORPORATION, ONE CUMMINGS POINT ROAD, STAMFORD, CT, 06902, US

(21) Appl. No.: 11/601,507

(22) Filed: Nov. 17, 2006

Related U.S. Application Data
(60) Provisional application No. 60/737,834, filed on Nov. 17, 2005.

(51) Int. Cl. E03C 1/08

(52) U.S. Cl. 239/428.5; 239/419.5; 239/407; 239/552; 239/601

(57) ABSTRACT

There is provided a showerhead device that includes a shower stem connector, a water/air mixing chamber, and an outlet cap. The shower stem connector includes a water inlet to receive water from a standard shower plumbing system and an air intake opening to receive air from outside the device. The preferred embodiment features an air intake opening located near the water inlet on the shower stem connector. A user can adjust the air intake knob in order to vary the amount of air that enters the device and mixes with the water flow. As the water progresses through a nozzle in the device, the speed of the water is increased by the decrease in diameter of the nozzle orifice. The water mixes with the air and the combination of water/air hits a plate on the inner wall of the outlet cap within the mixing chamber. This oxygenation of the water provides for a better water flow though the showerhead device. The mix of water and air provides for a stronger water flow and a better shower experience for a user. By having the air intake further upstream, it enables a user to adjust the amount of air mixed in.

### CROSS-REFERENCE TO RELATED APPLICATIONS

This application claims priority to U.S. Provisional Patent Application Ser. No. 60/737,834 filed on Nov. 17, 2005, incorporated herein by reference in its entirety.

### BACKGROUND OF THE INVENTION

1. Field of the Invention

The present invention relates to showerhead devices. More particularly, the present invention relates to a wall-mounted or handheld showerhead that oxygenates the water stream as it flows through the device.

2. Description of Related Art

It is known in the art to attach showering devices, such as assemblies of multiple showerheads and various moving and water spraying structures to the existing stem pipe supplying water from the standard shower plumbing system. Some shower devices enable a user to mix air with the water flow. However, these devices take air in near the water outlet and do not allow a user to adjust the amount of air intake.

There is a need for a device that can enable a user to selectively mix oxygen with the water supply to provide for different shower sensations in an effective way. There is also a need for internal geometric configurations that provide the most efficient mixing of water and air.

### OBJECT AND SUMMARY OF THE INVENTION

It is an object of the present invention to overcome the shortcomings of the prior art mentioned above. These and other objects are achieved by the present invention described herein.

The present invention achieves these and other objectives by providing a showerhead device that includes a shower stem connector, a water/air mixing chamber, and an outlet cap. The shower stem connector includes a water inlet to receive water from a standard shower plumbing system and an air intake opening to receive air from outside the device.

The preferred embodiment features an air intake opening located near the water inlet on the shower stem connector. The amount of air taken into the device can be controlled through the use of an intake knob. A user can adjust the air intake knob in order to vary the amount of air that enters the device and mixes with the water flow. As the water progresses through a nozzle in the device, the speed of the water is increased by the decrease in diameter of the nozzle orifice.

The water mixes with the air taken in through the air intake opening and the combination of water/air hits a plate on the inner wall of the outlet cap within the mixing chamber. This oxygenation of the water provides for a better water flow though the showerhead device. The mix of water and air provides for a stronger water flow and a better shower experience for a user. By having the air intake further upstream, it enables a user to adjust the amount of air mixed in.

### BRIEF DESCRIPTION OF THE DRAWINGS

The present invention is more fully understood by reference to the following detailed description of an illustrative embodiment with the drawings identified below.

FIG. 1 is a perspective view of a showerhead device in accordance with a preferred embodiment of the present invention.

FIG. 2 is a magnified perspective view of an air intake knob of the showerhead device in accordance with a preferred embodiment of the present invention.

FIG. 3A is a partial side cross-sectional view of the showerhead device, showing the shower stem connector and mixing chamber, of FIG. 1.

FIG. 3B is a front view of View A from FIG. 3A, showing a cross-section of the nozzle outlet.

FIG. 4A is a partial side cross-sectional view of the showerhead device, showing the outlet cap, of FIG. 1.

FIG. 4B is a front view of View B from FIG. 4A, showing a cross-section of the plate.

FIG. 5 is a schematic view of the interior of the showerhead device, illustrating the mixing of air and water, in accordance with a preferred embodiment of the present invention.

FIG. 6 is a perspective view of an alternate embodiment of the present invention.

### DETAILED DESCRIPTION OF THE INVENTION

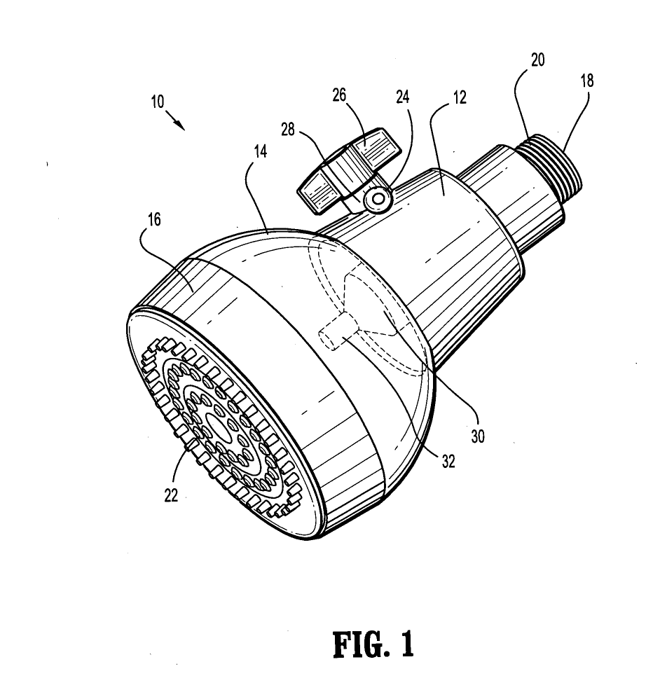

FIG. 1 shows a showerhead device 10 in accordance with a preferred embodiment of the present invention. The showerhead device 10 can be ergonomically shaped and include a shower stem connector 12, a mixing chamber 14, and an outlet cap 16. The shower stem connector 12 can include a water inlet 18 to receive water from a standard shower plumbing system. The stem connector 12 can have a number of threads 20 in order to be screwed onto the existing stem pipe. However, any other method of connection can be utilized.

The mixing chamber 14 is attached to the shower stem connector 12 though the use of screw threads to enable the mixing chamber 14 to be screwed into the stem connector 12, or can be attached by any other practical method. In one embodiment, the mixing chamber 14 and stem connector 12 can be fabricated as one piece. In the preferred embodiment, the mixing chamber 14 is clear or translucent in order to enable a user to see the water as it is being mixed. In an alternate embodiment, the mixing chamber 14 can be opaque.

The outlet cap 16 is similarly attached to the mixing chamber 14 though the use of screw threads, or any other practical method. The outlet cap has a number of small water outlets 22 to enable the water to flow from the device 10. The water outlets 22 can be in any of a variety of patterns to achieve a variety of spray patterns. In the preferred embodiment, the water outlets 22 can grouped together in a set of increasingly smaller diameters. The water outlets 22 can all be the same size or can have a number of different sizes. The water outlets 22 can be placed in a predetermined pattern or can be randomly placed on the outlet cap 22.

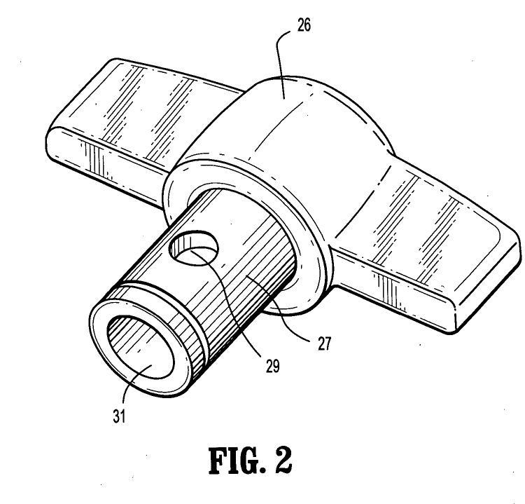

In a preferred embodiment, an air intake opening 24 is located near the water inlet 18 on the shower stem connector 12. Preferably, the air intake opening 24 is located on a flange 28 of the shower stem connector 12. The amount of air taken into the device 10 can be controlled through the use of an air intake knob 26, as shown in FIG. 2. The air intake knob 26 preferably has a projection 27 that extends into the flange 28 of the shower stem connector 12, past the air intake opening 24. Preferably, the projection 27 of the air intake knob 26 can have a hole 29 with a corresponding size and shape as the air intake opening 24. However, in an alternate embodiment, the hole 29 in the air intake knob 26 and the air intake opening 24 can have different sizes and shapes. When the hole 29 in the air intake knob 26 and the air intake opening 24 are aligned, the outside air flows into the air intake opening 24, through the hole 29 into the projection 27 and out the knob outlet 31 into the mixing chamber 14.

A user can adjust the air intake knob 26 in order to vary the amount of air that enters the device 10 and mixes with the water flow. When the air intake opening 24 and the hole 29 in the air intake knob 26 are aligned, the air intake is at a maximum. As a user rotates the knob 26, the hole 29 begins to eclipse the opening 24, thereby cutting off or decreasing the amount of air intake. Once the hole 29 and the opening 24 are completely misaligned, no air is capable of entering the air intake opening 24. In one embodiment, the knob 26 can be given a maximum rotating range of 180 degrees. This can provide an easier way for a user to align the holes to determine the amount of air intake. However, other ranges can be contemplated, such as a range of 90 degrees. This oxygenation of the water provides for a better water flow though the showerhead device 10. In alternate embodiments, the air intake knob 26 can be in the form of a dial, switches, buttons or any other method to enable a user to selectively control the amount of air that enters the showerhead 10.

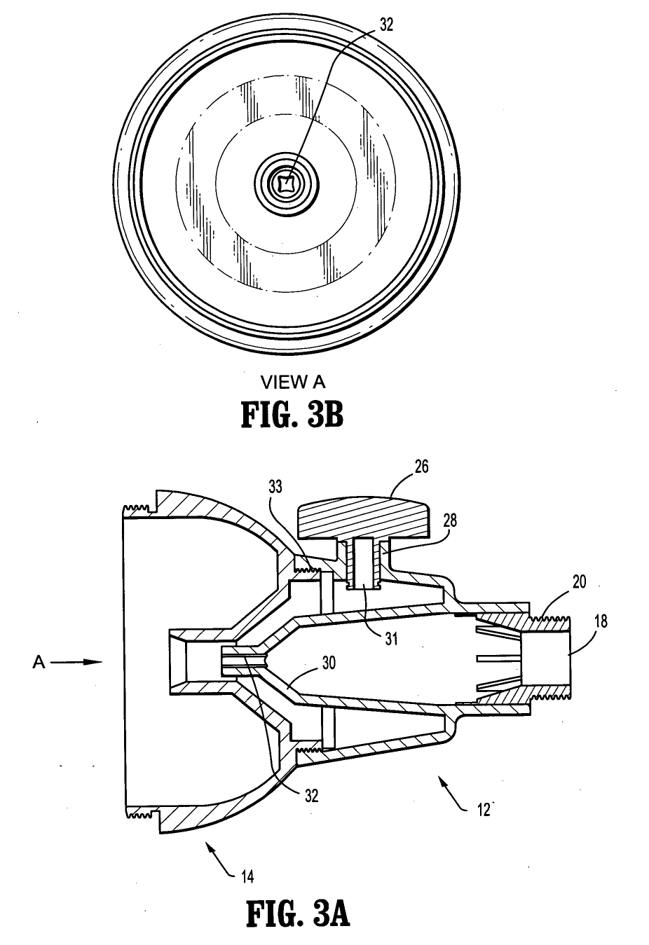

Within the mixing chamber 14 is a nozzle 30 that receives water from the water inlet 18 and directs it into the mixing chamber 14. As the water progresses through the nozzle, the speed of the water is increased by the decrease in diameter of the nozzle orifice 32. The orifice 32 can have any one of a variety of cross-sectional shapes. For example, the cross-section can be in the shape of a circle, a square, an ellipse, or any other effective shape. FIG. 3A shows a side cross-sectional view of the shower stem connector and mixing chamber, illustrating the nozzle 30 and nozzle orifice 32. FIG. 3B shows the View A from FIG. 3A, illustrating a cross-sectional view of one example of the orifice 32. With the relative small cross-sectional size of the orifice 32, the water moves into the mixing chamber 14 at a high velocity toward the inner wall of the outlet cap 16.

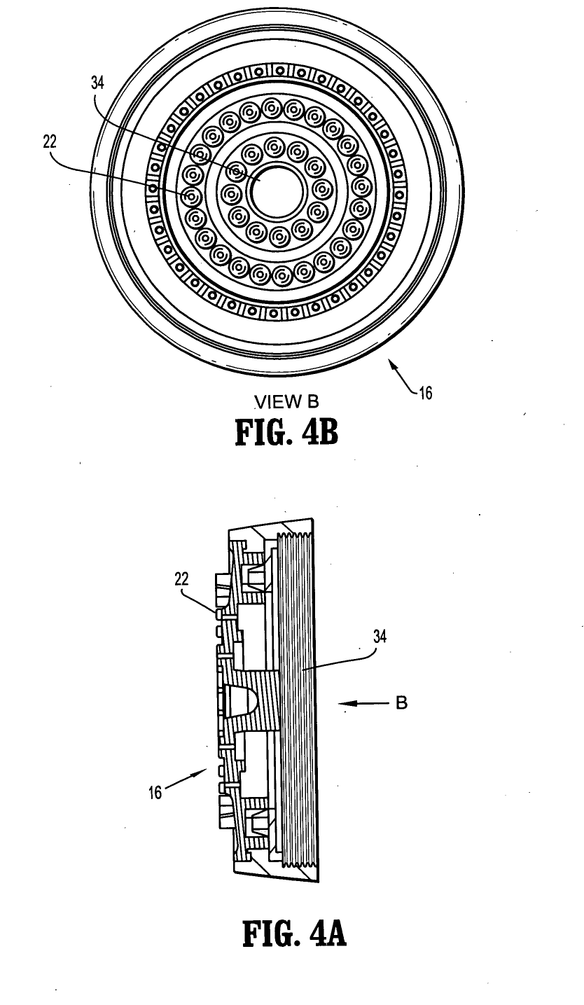

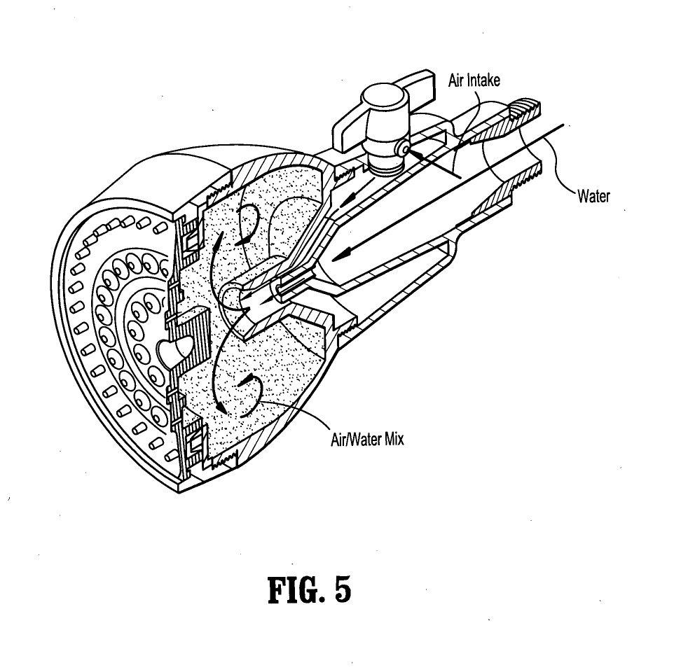

The water mixes with the air taken in through the air intake opening 24 and the combination of water and air hits a plate 34 on the inner wall of the outlet cap 16 within the mixing chamber 14. FIG. 4A shows a cross-sectional view of the outlet cap, illustrating the plate 34. FIG. 4B shows the View B from FIG. 4A, illustrating a cross-sectional view of one example of the plate 34. The shape of this plate 34 is preferably slightly concave, as shown in FIG. 4A. However, other shapes can be utilized, such as flat, slightly convex, or semi-spherical, for example. This mix of water and air provides for a stronger water flow and a better shower experience for a user. By having the air intake further upstream, it enables a user to adjust the amount of air mixed in. FIG. 5 shows the interior of the showerhead device, illustrating the mixing of air and water.

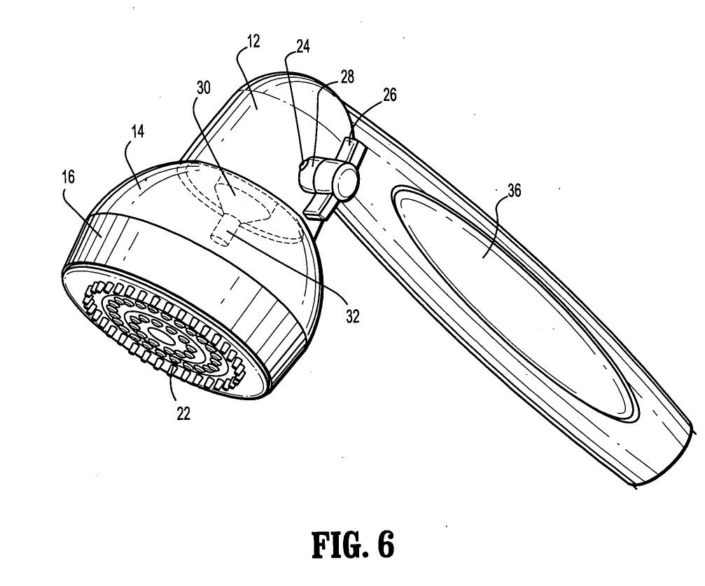

These features can also be present in a handheld shower device, as shown in FIG. 6. The feature of the shower stem connector 12 can be extended to include a handle portion 36. However, the other components, including the air intake knob 26 and nozzle 30 can function in a similar manner.

While a preferred embodiment of the invention has been herein disclosed and described, it is understood that various modifications can be made without departing from the scope of the invention.

What is claimed is:

1. A showerhead comprising:
a water inlet for receiving water;
a water outlet;
an air inlet;
an air intake knob to enable a user to selectively control the amount of air taken into said air inlet; and
a mixing chamber for mixing said water and said air.

2. A showerhead according to claim 1, further comprising
a nozzle to receive water from said water inlet and direct said water into said mixing chamber.

3. A showerhead according to claim 2, wherein
said nozzle further comprises a nozzle orifice having a relatively small diameter to increase the speed of said water as it passes through said nozzle.

4. A showerhead according to claim 3, wherein
said nozzle orifice can have any one of a variety of cross-sectional shapes.

5. A showerhead according to claim 1, wherein
said water outlet comprises an outlet cap having a plurality of holes.

6. A showerhead according to claim 5, further comprising
a plate adjacent to an inner wall of said outlet cap to further mix said water and said air.

7. A showerhead according to claim 6, wherein
said plate has a slightly concave surface.

8. A showerhead according to claim 6, wherein
said plate has any one of a variety of surface shapes.

9. A showerhead according to claim 1, wherein
said air intake knob further comprises a projection having a hole that can be selectively aligned with said air inlet to enable a user to control the amount of air taken in.

10. A showerhead according to claim 9, wherein
said air inlet is located on a flange connected to said showerhead at a location closer to said water inlet than said water outlet.
